(19) United States
(12) Patent Application Publication
(10) Pub. No.: US 2006/0010028 A1
(43) Pub. Date: Jan. 12, 2006

(54) Video shopper tracking system and method

(76) Inventor: Herb Sorensen, Troutdale, OR (US)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 10/989,828

(22) Filed: Nov. 15, 2004

Related U.S. Application Data
(60) Provisional application No. 60/520,545, filed on Nov. 14, 2003.

(51) Int. Cl. G06Q 30/00

(52) U.S. Cl. 705/10; 705/7

(57) ABSTRACT

A system and method are provided for video tracking of shopper movements and behavior in a shopping environment. The method typically includes displaying on a computer screen of a computing device a video recording of a shopper captured by a video camera in a shopping environment. The method may further include, while the video is being displayed, receiving user input via user input device of the computing device, the user input indicating a series of screen locations at which the shopper appears in the video, the series of screen locations forming a shopper path through the shopping environment. Each screen location is typically expressed in screen coordinates. The method may further include translating the screen coordinates into store map coordinates. The method may further include displaying a store map window featuring a store map with the shopper trip in store map coordinates overlaid thereon.

### CROSS-REFERENCE TO RELATED APPLICATION

This application claims priority under 35 U.S.C. § 119 to U.S. provisional patent application Ser. No. 60/520,545, entitled “VIDEO SHOPPER TRACKING SYSTEM AND METHOD,” filed on Nov. 14, 2003, the entire disclosure of which is herein incorporated by reference.

### TECHNICAL FIELD

The present invention relates generally to a shopper tracking system and method, and more particularly to a video shopper tracking system and method.

### BACKGROUND

A wide variety of goods are sold to consumers via a nearly limitless array of shopping environments. Manufacturers and retailers of these goods often desire to obtain accurate information concerning the customers' shopping habits and behavior, in order to more effectively market their products, and thereby increase sales. Tracking of shopper movements and behavior in shopping environments is especially desirable due to the recent development of sophisticated methods and systems for analysis of such tracking data, as disclosed in U.S. patent application Ser. No. 10/667,213, entitled SHOPPING ENVIRONMENT ANALYSIS SYSTEM AND METHOD WITH NORMALIZATION, filed on Sep. 19, 2003, the entire disclosure of which is herein incorporated by reference.

One prior method of tracking shopper movements and habits uses RFID tag technology. Infrared or other wireless technology could as well be used, as disclosed in the above mentioned application and in U.S. patent application Ser. No. 10/115,186 entitled PURCHASE SELECTION BEHAVIOR ANALYSIS SYSTEM AND METHOD, filed Apr. 1, 2002, the entire disclosure of which is herein incorporated by reference. However, such wireless tracking techniques are of limited use for shopping environments in which shoppers do not commonly use shopping baskets or carts. Video surveillance of shoppers is an approach that shows some promise in this area. However, previous attempts to pursue computerized analysis of video images have not been completely satisfactory.

It would be desirable to provide a system and method for computerized analysis of video images to identify people, their paths and behavior in a shopping environment.

### SUMMARY

A system and method are provided for video tracking of shopper movements and behavior in a shopping environment. The method typically includes displaying on a computer screen of a computing device a video recording of a shopper captured by a video camera in a shopping environment. The method may further include, while the video is being displayed, receiving user input via user input device of the computing device, the user input indicating a series of screen locations at which the shopper appears in the video, the series of screen locations forming a shopper path through the shopping environment. Each screen location is typically expressed in screen coordinates. The method may further include translating the screen coordinates into store map coordinates. The method may further include displaying a store map window featuring a store map with the shopper trip in store map coordinates overlaid thereon. A trip segment window may be displayed into which a user may enter information relating to a segment of the shopper trip displayed in the video. In addition, a demographics window may be displayed into which a user may enter demographic information for each shopper trip.

### BRIEF DESCRIPTION OF THE DRAWINGS

FIG. 1 is a schematic view of a system for video tracking of shoppers in a shopping environment, according to one embodiment of the present invention.

FIG. 2 is a schematic view of a video monitored shopping environment of the system of FIG. 1.

FIG. 3 is a schematic view of a computer-aided video tracking system of the system of FIG. 1.

FIG. 4 is schematic view of a shopper tracking window of the system of FIG. 1.

FIG. 5 is a schematic view of a trip segment window of the system of FIG. 1.

FIG. 6 is a first block diagram illustrating use of a transformative map by the system of FIG. 1.

FIG. 7 is a second block diagram illustrating use of a transformative map by the system of FIG. 1.

FIG. 8 is a third block diagram illustrating use of a transformative map by the system of FIG. 1.

FIG. 9 is a schematic view of a demographics window of the system of FIG. 1.

FIG. 10 is a schematic view of a store map window of the system of FIG. 1.

FIG. 11 is a schematic view of shopper trip interpolation performed by the system of FIG. 1.

FIG. 12 is a flowchart of a method according to one embodiment of the present invention.

### DETAILED DESCRIPTION OF THE PREFERRED EMBODIMENT

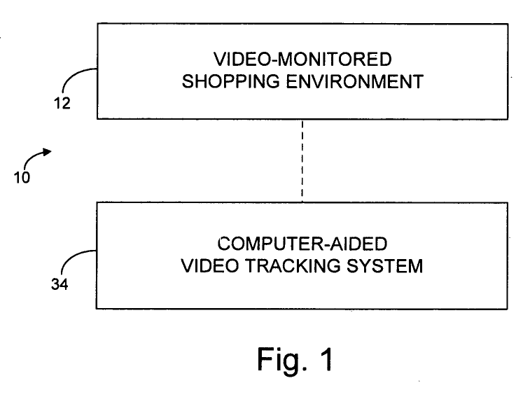

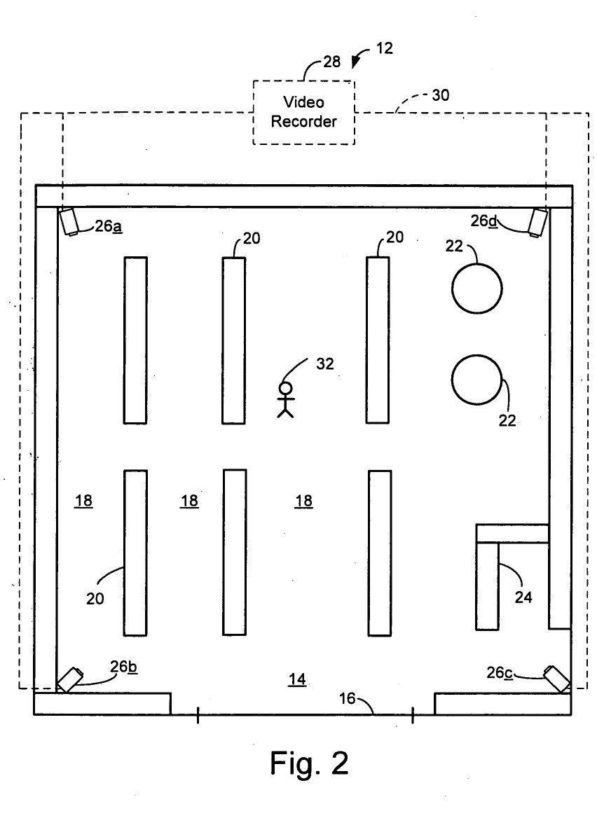

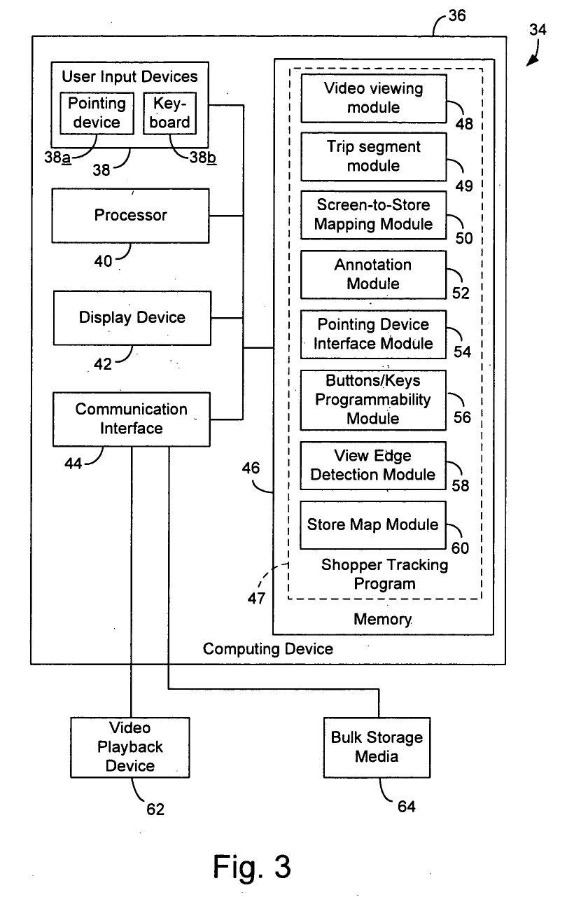

Referring to FIG. 1, a system for tracking shopper movements and habits in a shopping environment is shown generally at 10. System 10 typically includes a video-monitored shopping environment 12 and an associated computer-aided video tracking system 34. Details of each of these components are shown in FIGS. 2 and 3.

Referring now to FIG. 2, the video-enabled shopping environment 12 includes a store shopping floor 14 including a store entrance/exit 16, and shopping aisles 18 which are defined by the walls of the shopping environment and/or by aisle displays 20. The shopping environment may also include additional, standalone, store displays 22. One or more checkout registers 24 may be located near entrance/exit 16.

In the embodiment shown, four video cameras 26a-26d provide coverage of entire shopping floor 14. For other embodiments, more or fewer video cameras may be used as needed, depending on store geometry and layout. Video cameras 26a-26d are preferably fitted with wide-angle lenses, although other suitable lenses may be employed.

A video recorder 28 is configured to record video images from each of video cameras 26a-26d. Communication link 30 provides connection between video recorder 28 and cameras 26a-26d. Video cameras 26a-26d are configured so that movements and behavior of a shopper 32 at any location on store shopping floor 14 will be tracked on at least one video camera.

FIG. 3 shows an embodiment of the computer-aided video tracking system 34 of FIG. 1. Computer-aided video tracking system 34 typically includes a computing device 36 having one or more user input devices 38 such as a pointing device 38a or a keyboard 38b. The pointing device may be, for example, a mouse, track ball, joystick, touch pad, touch screen, light pen, etc. Computing device 36 further typically includes a processor 40, display device 42, communication interface 44, and memory 46. Memory 46 may include volatile and non-volatile memory, such as RAM and ROM. A video playback device 62 and/or bulk storage media 64 may be connected to computing device 36 via communication interface 44.

Computing device 36 is configured to execute a shopper tracking program 47, using processor 40 and portions of memory 46. Shopper tracking program 47 typically includes a video viewing module 48, trip segment module 49, screen-to-store mapping module 50, annotation module 52, and pointing device interface module 54. The shopper tracking program 47 may further include buttons/keys programmability module 56, view edge detection module 58, and store map module 60.

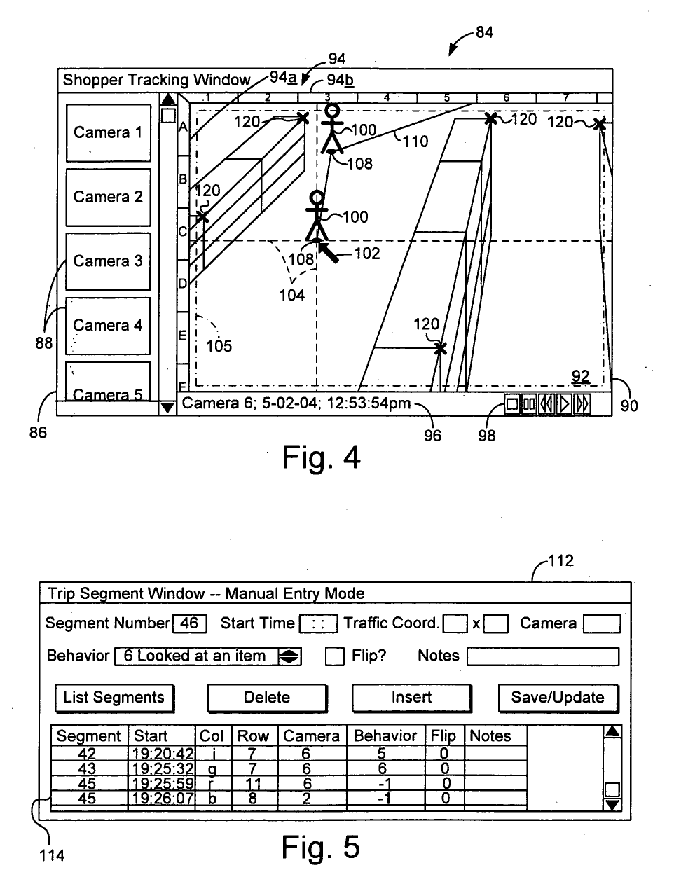

As shown in FIG. 4, video viewing module 48 is typically configured to generate shopper tracking window 84, which is displayed via display device 42 of computing device 36. Shopper tracking window 84 typically includes a camera selection pane 86 configured to enable a user to select video recordings from one of a plurality of cameras 26a-26d in shopping environment 14, by selecting a corresponding camera icon 88. Shopper tracking window 84 further includes a video pane 90 configured to display a video recording 92 from the selected camera. The video recording typically shows a portion of the shopping environment, from the point of view of the selected camera, in which a shopper 100 may be observed shopping.

Video information 96, such as the selected camera, and the time and date of the video is typically displayed within the shopper tracking window. Video playback controls 98 (including stop, pause, rewind, play, and fast forward) are typically provided to enable the mapping technician to navigate the video recording. A slider control may provide for “seek” capability, and may also show video play progress. The video pane may also provide zoom-in and zoom-out functionality. Typically, an image from a paused video may be sent to a printer or saved to a file, if desired.

Shopper tracking window 84 further includes a screen coordinate system 94, having vertical and horizontal grid markings 94a, 94b. A cursor 102 may be provided that is movable via pointing device 38a. Reference lines 104 may be provided so that a mapping technician may easily identify the position of the cursor relative to the screen coordinate system 94.

As the video recording is played, the mapping technician may track the shopper by inputting a series of screen locations at which the shopper is observed shopping, which are referred to as screen shopping points 108, or simply shopper locations 108. The mapping technician may input these locations by clicking (typically left-clicking) with the cursor on the video pane at a predetermined location relative to the shopper image (typically at the shopper's feet), to cause the shopper tracking window 84 to automatically record the time, date, and location of the screen shopping point. The shopping point is typically recorded in screen coordinates, such as pixels, or x-y screen coordinates on screen coordinate system 94. The mapping technician may alternatively right-click using the pointing device to call up the trip segment window 112, shown in FIG. 5, and manually input the screen coordinates making reference to screen coordinate system 94. The series of screen shopping points may be linked together as a whole to form a shopping path 110.

As shown in FIG. 5, trip segment module 49 is configured to cause trip segment window 112 to be displayed. Trip segment window typically includes entry fields for segment number, start time, traffic coordinates (i.e. screen coordinate of the current shopping point), camera number, behavior, flip, and notes. Input for the behavior field is typically selected from a pull down menu of pre-identified shopping behaviors, such as “looked at an item.” The flip indicator is selected to indicate that a shopper “flipped” an item, i.e., picked up an item, and then returned the item to the shelf. The notes field is typically a text field that may be used to enter miscellaneous information about the trip segment that may be observable in the video recording.

The trip segment window also includes a segment list pane 114 including a numbered list of the trip segments associated with the shopper trip. Clickable buttons above the summary list pane may provide for deletion of selected segments, insertion of a new segment, and saving/updating of current segment data. By selecting a particular row in the summary list pane, a user may edit the information associated with a trip segment.

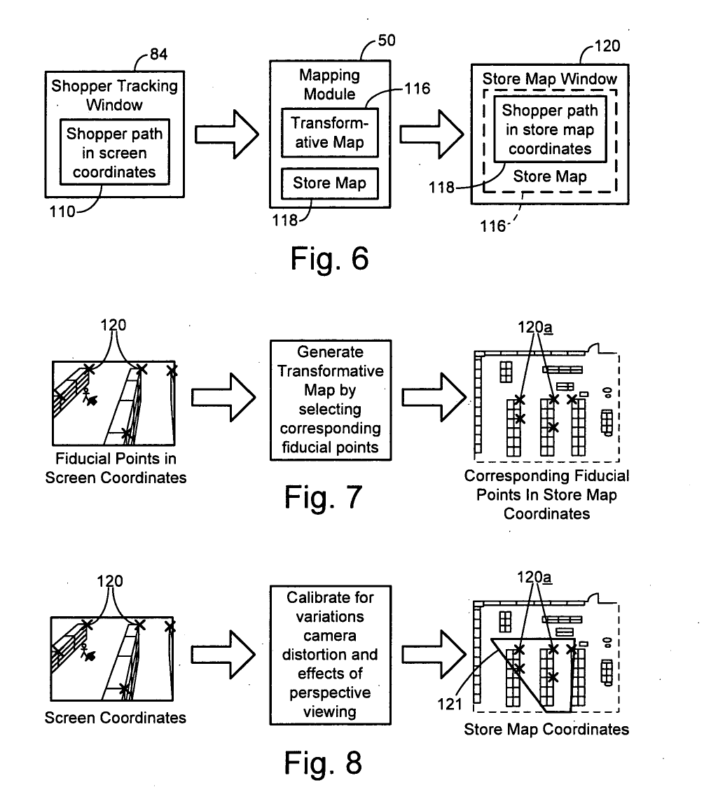

As illustrated in FIGS. 6-8, screen-to-store mapping module 50 is configured to translate the shopper path from screen coordinates to store map coordinates. The screen-to-store mapping module 50 typically includes a transformative map 116 for each of cameras 26a-26d, and a store map 118. As illustrated in FIG. 6, the screen-to-store mapping module is typically configured to take shopper path data expressed in screen coordinates entered by a mapping technician via shopper tracking window, and apply transformative map 116 to the screen coordinates, to produce a shopper path expressed in store map coordinates. The shopper path may be displayed on the store map in a store map window 120.

Transformative map 116 is typically a look-up table that lists screen coordinates and corresponding map coordinates. Typically, a separate transformative map is provided for each of cameras 26a-26d. Alternatively, the map may be an algorithm, or other mechanism that may be applied to all of the cameras, for translating the coordinates from screen coordinates to store map coordinates.

As shown in FIGS. 7-8, the transformative map itself may be generated by selecting a plurality of fiducial points 120 in the video pane, which correspond to fiducial points 120a on the store map. From the relationships between these fiducial points, the mapping module 50 is configured to interpolate to create relationships between surrounding coordinates, and to calibrate the relationships to accommodate camera distortion (e.g., due to wide-angle lenses), the perspective effects of the camera view, etc. The result is a transformative map that is configured to translate screen coordinates within a field of view of a camera, to map coordinates within a corresponding camera field of view (see 121 in FIG. 8) on the store map.

One method of setting these fiducial points, referred to as “manual calibration,” is to position individuals within the camera view so their feet coincide with a specific screen coordinate (e.g. A:3), and then associate a corresponding store map coordinate with that screen coordinate. The results may be stored in a manually generated lookup table. Alternatively, other methods may be employed, such as the use of neural networks.

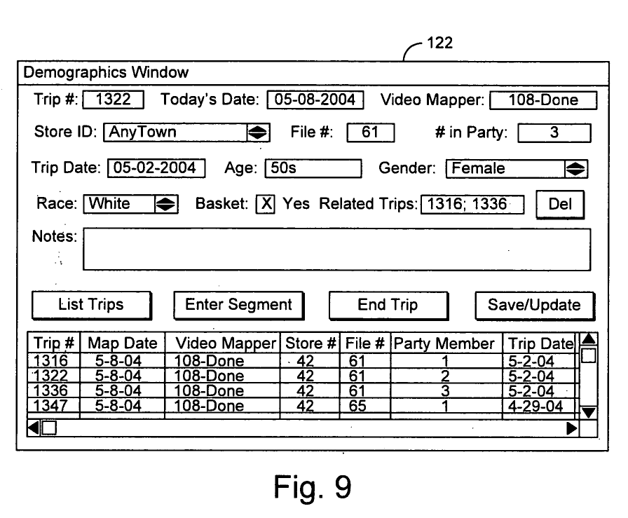

As shown in FIG. 9, annotation module 52 is typically configured to launch a demographics window 122. Demographics window 122 typically includes a plurality of entry fields by which a mapping technician may enter information relating to an entire shopping trip taken by a shopper. Demographics window 122 may include entry fields by which the mapping technician may input a trip number, data entry date, mapping technician identifier, store identifier, file number, number of shoppers in a shopping party being mapped, trip date, age of shopper, gender of shopper, race of shopper, basket indicator to indicate whether a shopper is carrying a basket/pushing a cart, related trip numbers, and notes. The age of the shopper is typically estimated by the mapping technician, but may be obtained by querying the shopper directly in the store, or by matching the shopper path with point of sale data, for example, if a user scans a member card that has age data associated therewith. Typically, if two shoppers are in a party, a shopper trip is mapped for each member of the party, and the shopper trips are indicated as related through the related trips indicator.

Demographics window 122 further contains a list pane that lists a numbered list of stored shopper trips. Buttons are included to list the trips, enter a new segment for a trip (which launches the trip segment window 112), an end trip button (which indicates to the system that all trip segments have been entered for a particular shopper trip), and a save/update button for saving or updating the file for the shopper trip.

Pointing device interface module 54 typically provides for streamlined annotation capability. Pointing device interface module 54 activates left and right buttons of the pointing device 38a, typically a mouse, so that a click of the left button, for example, records screen coordinates corresponding to the location of the cursor 102 on the display device, and the time, date, and camera number for the video recording being displayed. A click of the right button may record screen coordinates corresponding to the location of the cursor, as well as time, date and camera information, and further cause trip segment window 112 to display, to enable the mapping technician to input additional information about the trip segment. In this way, a mapping technician may input an observed behavior, or add a note about the shopper behavior, etc., which is associated with the trip segment of the shopper path record.

In use, the mapping technician typically follows the path of a shopper on the screen with the cursor (typically pointing to the location of the shopper's feet). Periodically—every few seconds or when specific behavior is observed such as a change in direction, stopping, looking, touching, purchasing, encountering a sales agent or any other desired event—the mapping technician may enter a shopping point by clicking either the left mouse button, which as described above instantly records the store map coordinates, time and camera number, or by clicking on the right mouse button, which additionally causes the trip segment window to pop up, providing fields for the mapping technician to input information such as shopping behaviors that have been observed.

Buttons/keys programmability module 56 enables an additional mouse button or other key to be assigned a function for convenience of data entry. For example, looking is a common shopping behavior, so it may be advantageous to have a third mouse button indicate the looking behavior without necessitating slowing up the mapping process to do the annotation. A mapping technician would click the third mouse button and the coordinate would be annotated automatically as a “look.”

View edge detection module 58 is typically configured to automatically notify the mapping technician of the correct camera view to which to switch, and also may be configured to bring up the next view automatically, when a shopper approaches the edge of one camera view (walks off the screen). For example, if a mapping technician follows the video image of a shopper with the cursor to a predefined region of the screen adjacent the edge of the video viewing pane (see region between dot-dashed line 124 and edge of pane in FIG. 4), the view edge detection module may be configured to calculate the appropriate camera based on the position of the cursor, and launch a pop-up window that prompts the user to switch cameras (e.g., “Switch to Camera 3?”). Alternatively, the view edge detection module may be programmed to switch camera views automatically based on a detected position of the cursor within the video pane, without prompting the user.

Store map module 60 is configured to launch store map window 126, which may be launched as a separate window or as a window inset within the shopper tracking window. Store map window 126 typically displays store map 118, which is typically in CAD format, but alternatively may be an image, or other format. As the mapping technician enters shopping trip segments via the shopper tracking window 84, the store map window is configured to display a growing map of the shopper trip 110a in store map coordinates, through the conversion of coordinates from screen coordinates to store map coordinates by the mapping module, discussed above. As compared to manual mapping, providing such a “live” view of a growing map of the shopper path in store map coordinates has been found useful, because it alerts the mapping technician to gross errors that may otherwise show up during the mapping, for example, hopping across store fixtures, etc.

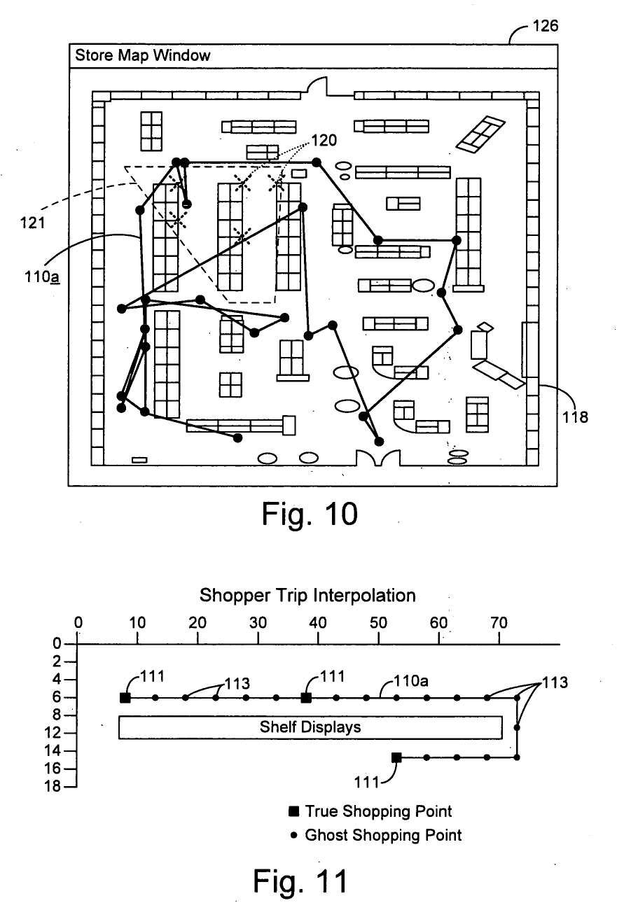

It will be appreciated that the shopper path 110a shown in FIG. 10 includes some trip segments that pass through store displays, and some trip segments that are separated by great distances, which may lead to unpredictable results in when analyzing the shopper path data. As shown in FIG. 11, for greater accuracy in reproducing the actual shopper trip, the shopper tracking program 47 may be configured to interpolate the path of a shopper trip between shopping points that are actually measured by a mapping technician.

To accomplish this, the shopper tracking program treats shopping points that are entered by a mapping technician as “true” shopping points 111, and creates “ghost” shopping points 113 at points in between. The location of ghost shopping points 113 typically is calculated by interpolating a line in between two consecutive true shopping points, and placing ghost shopping points at predetermined intervals along the line. However, when a mapping technician enters consecutive shopping points on opposite sides of a store display, which would cause a straight line between the two to travel through the store display, the shopper tracking program typically calculates a path around the display, and enters ghost shopping points at predetermined intervals along the calculated path, as shown. The path may be calculated, for example, by finding the route with the shortest distance that circumnavigates the store display between the two consecutive true shopper points. It will be appreciated that this interpolation may be performed on data already entered by a mapping technician, or in real time in the store map window as a mapping technician maps points in shopper tracking window 84, so that the mapping technician may identify errors in the interpolated path during data entry. The resulting interpolated shopper trip generally includes more shopper points, which may be used by analysis programs as a proxy of the shopper's actual position, and which travels around store displays, more closely resembling an actual shopper's path.

It will be appreciated that the shopper trip window, the trip segment window, the demographics window, and the store map window are movable on display 42, by placing the mouse cursor on the top bar of the respective window and pressing the left mouse button and moving the window accordingly. Thus, it will be appreciated that all portions of the shopper tracking window may be viewed by moving any overlaid windows out of the way. In addition, each of the windows can be minimized or expanded to full screen size by use of standard window controls.

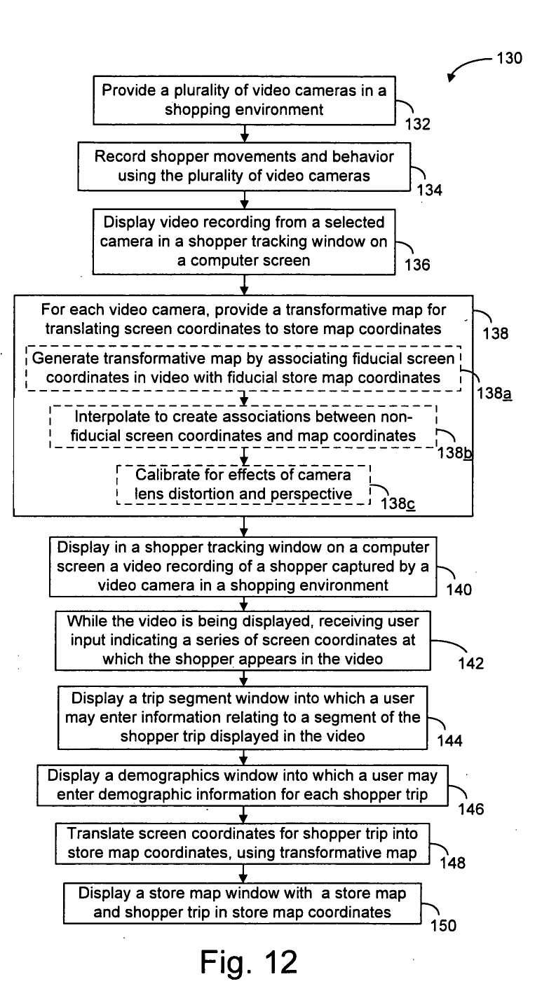

FIG. 12 shows an embodiment of the method of the present invention at 130. Method 130 typically includes, at 132, providing a plurality of video cameras in a shopping environment. As described above, the video cameras may be fitted with wide-angle lenses and are typically positioned to provide full coverage of the shopping environment, or a selected portion thereof.

At 134, the method typically includes recording shopper movements and behavior with the plurality of video cameras, thereby producing a plurality of video recordings. At 136, the method typically includes displaying a video recording from a selected camera in a shopper tracking window on a computer screen.

At 138, the method typically includes, for each video camera, providing a transformative map for translating screen coordinates to store map coordinates. As shown at 138a-138c, this may be accomplished by associating fiducial screen coordinates in the video recording with fiducial store map coordinates, interpolating to create associations between non-fiducial screen coordinates and map coordinates, and calibrating for effects of camera lens distortion and perspective.

At 140, the method includes displaying in a shopper tracking window on a computer screen a video recording of a shopper captured by a video camera in the shopping environment. At 142, the method includes receiving user input indicating a series of screen coordinates at which the shopper appears in the video, while the video is being displayed. As described above, these screen coordinates may be entered by clicking with a pointing device on the location of the shopper in the video recording, by manually through a trip segment window, or by other suitable methods. At 144, the method includes, in response to a user command such as right clicking a pointing device, displaying a trip segment window into which a user may enter information relating to a segment of the shopper trip displayed in the video.

At 146, in response to a user command such as a keyboard keystroke, the method includes displaying a demographics window into which a user may enter demographic information for each shopper trip. At 148, the method includes translating screen coordinates for shopper trip into store map coordinates, using the transformative map. And, at 150, the method includes displaying a store map window with a store map and the shopper trip expressed in store map coordinates, as shown in FIG. 10.

By use of the above-described systems and methods, mapping technicians may more easily and accurately construct a record of shopper behavior from video recordings made in shopping environments.

Although the present invention has been shown and described with reference to the foregoing operational principles and preferred embodiments, it will be apparent to those skilled in the art that various changes in form and detail may be made without departing from the spirit and scope of the invention. The present invention is intended to embrace all such alternatives, modifications and variances that fall within the scope of the appended claims.

1. A method of tracking shopper behavior in a shopping environment, comprising:
displaying on a computer screen of a computing device a video recording of a shopper captured by a video camera in a shopping environment; and
while the video is being displayed, receiving user input via user input device of the computing device, the user input indicating a series of screen locations at which the shopper appears in the video, the series of screen locations forming a shopper path through the shopping environment.

2. The method of claim 1, wherein the screen locations are input using a pointing device.

3. The method of claim 1, wherein each screen location is expressed in screen coordinates.

4. The method of claim 3, wherein the screen coordinates are indicated in pixels.

5. The method of claim 3, further comprising, translating the screen coordinates into store map coordinates.

6. The method of claim 5, wherein translating the screen coordinates into store map coordinates is accomplished at least in part by use of a transformative map including a look-up table with corresponding screen coordinates and store map coordinates listed therein.

7. The method of claim 6, wherein the look-up table is generated by identifying a plurality of fiducial coordinates in the video recording on the computer screen, and associated fiducial coordinates in a store map.

8. The method of claim 7, wherein the look-up table is further generated by interpolating from the corresponding fiducial coordinates to create associations between non-fiducial coordinates.

9. The method of claim 8, wherein the look-up table is further calibrated to account for camera lens distortion.

10. The method of claim 8, wherein the look-up table is further calibrated to account for perspective.

11. The method of claim 5, further comprising, displaying a store map window with a store map and shopper trip in store map coordinates displayed therein.

12. The method of claim 5, wherein the map coordinates represent true shopping points entered by a mapping technician, the method further comprising calculating ghost shopping points intermediate the true shopping points, along the shopper path.

13. The method of claim 12, wherein the ghost shopping points are calculated to extend around store displays.

14. The method of claim 1, further comprising, in response to a user command, displaying a trip segment window into which a user may enter information relating to a segment of the shopper trip displayed in the video.

15. The method of claim 1, further comprising, in response to a user command, displaying a demographics window into which a user may enter demographic information for each shopper trip.

16. A method of tracking shopper behavior in a shopping environment monitored by a plurality of video cameras, comprising:
providing a user interface on a computing device for viewing a video recording taken by a selected video camera monitoring the shopping environment;
providing a mapping module configured to translate screen coordinates for the selected camera into map coordinates in a store map;
displaying on a computer screen a video recording of a shopper captured by the video camera in a shopping environment;
while the video is being displayed, receiving user input from a user input device indicating a series of screen coordinates at which the shopper appears in the video; and
translating the series of screen coordinates into a corresponding series of map coordinates on the store map.

17. The method of claim 16, wherein the mapping module includes a lookup table.

18. The method of claim 17, wherein the lookup table is generated at least in part by associating fiducial screen coordinates with corresponding fiducial map coordinates.

19. The method of claim 18, wherein the lookup table is generated at least in part by interpolating from the fiducial coordinate associations, to create associations between non-fiducial coordinates.

20. The method of claim 19, wherein the lookup table is generated at least in part by further calibrating the lookup table to account for camera distortion.

21. The method of claim 19, wherein the lookup table is generated at least in part by further calibrating the lookup table to account for perspective.

22. A method of tracking shopper behavior in a shopping environment having a store map with x-y coordinates, the method comprising:
providing a plurality of video cameras in the shopping environment;
recording shopper movements using the plurality of video cameras;
providing a computing device having a screen and a pointing device;
providing a shopper tracking window configured to display a video recording from a camera in a video pane having a screen coordinate system;
providing a store map window configured to display a store map;
for each video camera, providing a transformative map associating screen coordinates to store map coordinates;
displaying a video recording from a selected camera in the video pane of the shopper tracking window;
receiving user input of screen coordinates corresponding to a path of a shopper in the video recording, the user input being received via detecting clicking of the pointing device on the screen while the video recording is being displayed;
translating the inputted screen coordinates to corresponding store map coordinates, using the transformative map for the selected camera, to thereby produce a shopper path in store coordinates; and
displaying the store map in the store map window, with a shopper path overlaid thereon.

23. A computer-aided video tracking system for tracking shopper behavior in a shopping environment, the shopping environment having a plurality of video cameras positioned therein to record shoppers in the shopping environment, the system comprising:
a computing device having a processor, memory, screen, and associated user input device;
a shopper tracking program configured to be executed by the computing device using the processor and portions of the memory, the shopper tracking program being configured to display a user interface including:
a shopper tracking window including a video viewing pane configured to display recorded video from the video camera, the shopper tracking window being configured to enable a user to select points in the video viewing pane using the user input device, to thereby record a series of screen coordinates at which a shopper is located during a shopping trip;
a trip segment window configured to enable a user to enter data related to a selected trip segment;
a demographics window configured to enable a user to enter demographic data related to a selected shopper trip;
a store map window configured to display a store map with the shopper trip mapped thereon in store map coordinates.

24. A computer-aided video tracking system for tracking shopper behavior in a shopping environment, the shopping environment having a plurality of video cameras positioned therein to record shoppers in the shopping environment, the system comprising:
a shopper tracking program configured to be executed at the computing device, the shopper tracking program including:
a video viewing module configured to display video from one of a plurality of input video cameras on the computer screen;
a pointing device interface module configured to enable a user to select a location on the screen at which a video image of a shopper appears, to thereby record information relating to a segment of a shopper trip; and
a screen-to-store mapping module configured to translate the location on the screen selected by the user to a corresponding location on a store map.

25. The computer-aided video tracking system of claim 22, wherein the screen location is expressed in screen coordinates, and the store map location is expressed in map coordinates, and the screen-to-store mapping module includes a look-up table that maps corresponding screen coordinates to store map coordinates.

26. The computer-aided video tracking system of claim 24, wherein the screen-to-store mapping module includes an association that is generated by computer calculation based on user selection of a set of fiducial points.

27. The computer-aided video tracking system of claim 24, wherein the shopping environment includes a plurality of video cameras, and wherein the video viewing module is configured to enable a user to select from among the plurality of video cameras to display on the computer screen.

28. The computer-aided video tracking system of claim 27, wherein the shopper tracking program further includes a camera view edge detection module configured to prompt a user to switch between camera views.

29. The computer-aided video tracking system of claim 24, wherein the screen locations entered by the mapping technician constitute true shopper points, and wherein the shopper tracking program is configured to interpolate between consecutive true shopper points to create ghost shopper points intermediate the consecutive true shopper points.

30. The computer-aided video tracking system of claim 29, wherein the ghost shopper points are calculated so as not to extend through physical barriers within the shopping environment.
